(19) United States
(12) Patent Application Publication
(10) Pub. No.: US 2022/0036765 A1
(43) Pub. Date: Feb. 3, 2022

(54) A Simulated Blood Vessel For Use In A Trauma Simulator

(71) Applicant: Trauma Simulation Limited, Swansea (GB)

(72) Inventor: Ian Pallister, Swansea (GB)

(21) Appl. No.: 17/276,318

(22) PCT Filed: Sep. 13, 2019
(86) PCT No.: PCT/GB2019/052570

§ 371 Date: Mar. 15, 2021

(30) Foreign Application Priority Data
Sep. 13, 2018 (GB) 1814929.4

(51) Int. Cl. G09B 23/30

(52) U.S. Cl. CPC G09B 23/303

(57) ABSTRACT

The present invention relates to a simulated blood vessel for use in a trauma simulator. The simulated blood vessel comprises a flexible, resilient body and has a fluid channel integrally moulded within the body. The fluid channel has first and second ends and a compression zone located lengthwise between the first and second ends that is compressible between an open configuration and a closed configuration in which flow through the fluid channel is blocked. The compression zone has a compression axis arranged transverse to the length of the fluid channel along which a compression force is applied to the fluid channel in use, and the compression zone has a cross sectional shape having a first axis aligned with the compression axis and a second axis arranged transverse to the first axis, and the diameter of the fluid channel along the second axis is greater than diameter along the first axis to enable the fluid channel to be more easily compressed to the closed configuration.

The present invention relates to a simulated blood vessel and in particular a simulated blood vessel for use in a trauma simulator.

Trauma simulation devices provide a real-time, and realistic means of training medical personnel and medical students in the surgical skills required to treat trauma patients, in a safe and controlled environment. Trauma simulation models may be used to train military surgeons in an immersive environment in which a real-life combat zone environment is re-created to simulate as closely as possible the conditions in which the surgeons may be required to operate. Such conditions may include the recreation of injuries inflicted by improvised explosive devices (IEDs), which can result in severe lower limb amputations and massive haemorrhage. In such circumstances, stemming blood flow from the patient is of critical importance, and requires the medical personnel to be able to implement the necessary point-of-wounding techniques, such as tourniquet, pelvic binder and haemostatic dressing application, in a quick, accurate and effective manner. It is therefore important that training aids react to the techniques applied by the medical personnel and mimic the human body in as realistic a manner possible to ensure that the techniques are being implemented correctly.

Trauma simulation dummies include a simulated circulation which is supplied with simulated blood to create real-time blood loss. Such dummies typically include an arrangement of synthetic flesh material and artificial bone, covered by a skin layer. Plastic tubing is located within the arrangement of flesh at a depth selected to represent a particular blood vessel. The plastic tubing will be arranged to simulate external blood loss, and a supply of simulated blood is connected to the plastic tubing and flows through the tubes to simulate blood flow.

In a point-of-wounding technique such as tourniquet, pressure is applied to the patient to compress the haemorrhaging blood vessel and occlude the vessel to stem blood flow. It has been found that the plastic tubing used to create a simulated circulation does not have the same characteristics of compression as real blood vessels, and therefore does not react in the same manner when pressure is applied by the trainee. It is therefore difficult to ascertain whether the wounding technical is being correctly applied.

It is therefore desirable to provide an improved simulated blood vessel and an improved trauma simulation device which address the above described problems and/or which offers improvements generally.

According to the present invention there is provided a simulated blood vessel as described in the accompanying claims. According to the present invention there is also provided a trauma simulation device as described in the accompanying claims.

In an embodiment of the invention there is provided a simulated blood vessel comprising a flexible, resilient body; and a fluid channel integrally moulded within the body. The fluid channel has first and second ends and a compression zone located lengthwise between the first and second ends that is compressible between an open configuration and a closed configuration in which flow through the fluid channel is blocked. The compression zone has a compression axis arranged transverse to the length of the fluid channel along which a compression force is applied to the fluid channel in use, and the compression zone has a cross sectional shape having a first axis aligned with the compression axis and a second axis arranged transverse to the first axis, and the diameter of the fluid channel along the second axis is greater than diameter along the first axis to enable the fluid channel to be more easily compressed to the closed configuration. As the width of the channel along the second axis is greater than its height along the first axis, the ratio of compression along the first axis to compression along the second axis required to occlude the fluid channel is reduced enabling the user to more effectively occlude the channel with an applied pressure corresponding to the pressure required or effective real-life treatment.

The first end of the fluid channel preferably defines an inlet and the second end defines an outlet and the first end of the fluid channel has a circular cross section. This enables the first end to effectively connect to a fluid supply connector.

The cross sectional shape of the fluid channel may transition along the length of the channel in a tapered manner from the circular cross sectional shape at the first end to the cross sectional shape of the compression zone. This ensures smooth flow of fluid along the channel, which may be effected by a step change in cross sectional shape.

The second end of end of the fluid channel has a circular cross section.

The cross sectional shape of the fluid channel preferably transitions along the length of the channel in a tapered manner from the cross sectional shape of the compression zone to the circular cross sectional shape at the first end.

The compression zone preferably has an elliptical or oval cross sectional shape.

The body is preferably formed from silicone.

The body preferably has an elongate cuboid form and the fluid channel is arranged lengthwise within the body. Preferably the body is rectangular cuboid. The cuboid form enables the body to be more easily moulded.

The simulated blood vessel may further comprise first and second expansion zones located on opposing sides of the compression zone along the second axis. The expansion zones are regions within the body having a greater compressibility than the rest of the body to enable the compression zone to more easily expand outwardly along the second axis when compressed along the first axis.

The first and second expansion zones may include first and second compression channels integrally moulded within the body and arranged parallel to and laterally spaced from the fluid channel such that they compress as the compression zone expands outwardly along the second axis. The channels are preferably cylindrical channels having a circular cross section, and may have a diameter less than the first and second diameters of the compression zone.

The first and second expansion zones may comprise a material of greater compressibility than the rest of the body, which may be a more compressible silicone or other material.

In another aspect of the invention there is provided a trauma simulator comprising a model simulating a human body or part thereof. The model may be a dummy or a replica of an anatomical part of the body, such as the lower body. The model contains an assembly of simulated internal body parts, such as bone(s), and muscle tissue, that are arranged to replicate the internal structure of the body, or body part, simulated by the model. The assembly of simulated body parts includes a simulated blood vessel as described above. The first end of the fluid channel is arranged for connection to a fluid supply for the supply of simulated blood, the second end is located at a region of the model simulating a wound and is arranged to create an external flow of simulated blood, and the compression zone is located at a region within the model corresponding to the location along the blood vessel to which a compression technique is to be applied, the compression zone being located such that application of a predetermined compression force to the model causes the compression zone to compress to the closed configuration. The depth and location of the simulated blood vessel is selected to simulate a selected blood vessel, and the compression zone is arranged at the location along the blood vessel where, for the injury simulated by the trauma simulator, pressure should be correctly applied to stem blood flow.

The assembly of simulated internal body parts includes simulated bone and simulated muscle tissue and an outer skin surrounds the internal body parts. The simulated blood vessel is located within the model between the outer skin and one of both of the simulated bone and the simulated muscle tissue, which provide a substrate that is less compressible than the body of the simulated blood vessel against which the simulated blood vessel may be compressed. Sandwiching the blood vessel in this way ensures it can be properly compressed, whereas the absence of a firm base beneath the blood vessel would result in the blood vessel compressing its substrate rather than being properly compressed itself.

The present invention will now be described by way of example only with reference to the following illustrative figures in which:

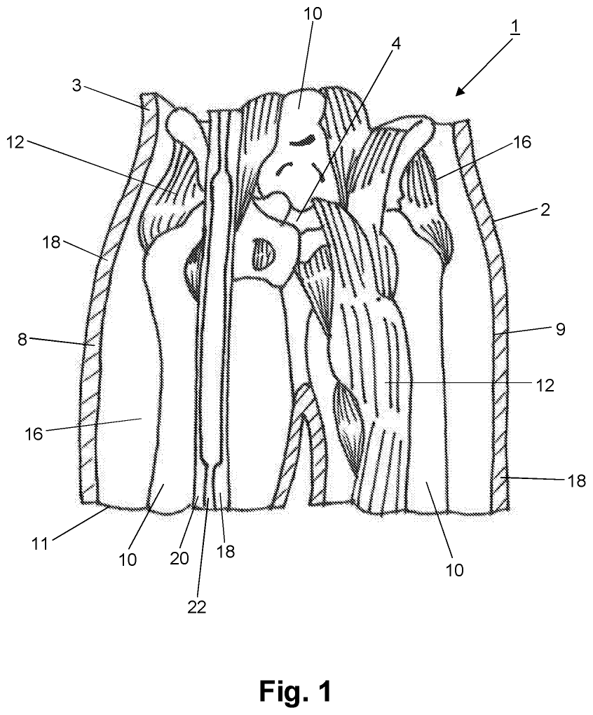

FIG. 1 show a cross sectional view of a trauma simulator according to an embodiment of the invention;

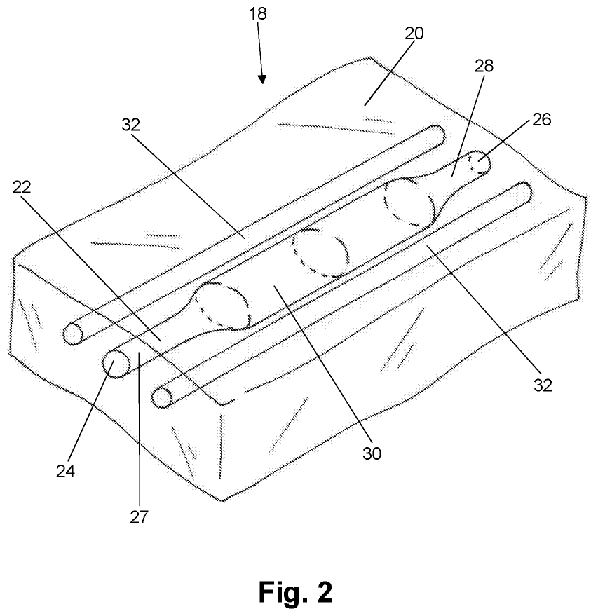

FIG. 2 shows a simulated blood vessel according to an embodiment of the invention; and

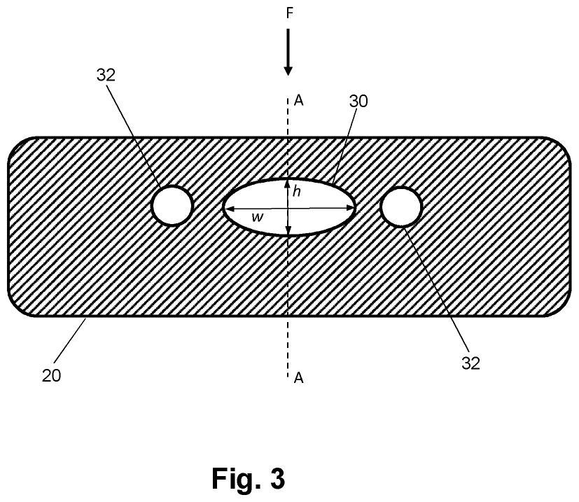

FIG. 3 shows a cross sectional view of the simulated blood vessel of FIG. 2.

FIG. 1 which shows a cross sectional view of a trauma simulator 1 for simulating an anatomical section of the body of a human patient. The simulator 1 comprises a body 2 representing a full scale model of a lower human body, although it will be appreciated that in alternative embodiments the simulator may replicate other anatomical sections or an entire human body. The simulator 1 includes a lower torso section 3, pelvis 4 and first and second upper leg sections 8,9. The upper leg sections 8,9 are truncated to simulate lower limb amputation in one or both of the legs.

The body 2 contains bones 10 formed from resin or similar material. Synthetic muscle tissue sections 12 are arranged about the bones 10 that are formed from rubber, latex, silicone or other material suitable to replicate the structure and texture of muscle tissue. For illustrative purposes, several muscle tissue sections 12 are not shown. A foam filler material 16 may also be provided in the voids between and surrounding the muscle tissue. A circulator system is also provided, which includes simulated blood vessel 18 selectively arranged within the leg 8 to simulate a pre-determined major blood vessel within the leg 8, such as the femoral artery, which in live patient would result in significant blood loss if severed. An external skin 18 is moulded about the internal structure which contains and consolidates the internal structure and provides a realistic external appearance.

The first leg 8 has a distal end 11, defining the point of amputation, and simulating a wound site at which the internal structure of the leg 8 is externally exposed. The simulated blood vessel 12 is selectively arranged within the leg 8 to simulate a pre-determined major blood vessel within the leg 8, such as the femoral artery, which in a live patient would result in significant blood loss if severed.

The simulated blood vessel 18 comprises an elongate body of flexible material 20 through which is formed a fluid channel 22 which defines the blood vessel. The body 20 is preferably formed of a resilient, flexible and compressible material such as silicone. FIG. 2 is an illustrative representation of the simulated blood vessel 18. The fluid channel 22 is moulded within the flexible body 20. The fluid channel 22 includes a first end 24 and a second end 26. First and second end sections 27,28 are located at the first and second ends 22,24 respectively. The first and second end sections 27,28 are cylindrical, having substantially circular cross section. The second end 28 defines an inlet to the channel 22 and is connected to a supply tube through which simulated blood flows into the channel 22. The first end 26 defines an outlet through which the simulated blood flow is expelled to simulate haemorrhage.

The channel 22 further includes a central section 30 located between the first and second end sections 26,28. The central section 30 is a compression zone that is arranged within the leg 8 at a location corresponding to the correct point of application of compression for a given wounding technique such tourniquet. It has been found that circular tubes used in arrangements of the prior art do not compress in-situ in a manner consistent with blood vessels. The central section 30 is therefore formed having a compressed, laterally expanded cross sectional form. Specifically, the cross sectional shape of the central section 30 is substantially oval or elliptical, having width that is greater than its height.

This enables the central section 30 to compress more effectively and a in manner more consistent with a real blood vessel. This means the trainee is able to occlude the channel 22 when applying the correct amount of pressure for real-life treatment.

As shown in FIG. 3, in use a compressive force F is applied by the trainee along a compression axis A-A substantially perpendicular of the surface of the body. The central section 30 of the fluid channel 22 has a cross sectional shape having a height h which in use is aligned with the compression axis A-A and a width w which is arranged transversely to the height h. The height h of the central section is less than the width w, such that the central section 30 has a compressed form. This has been found to improve the compression characteristics of the simulated blood vessel 20, making is easier to compress which in practice means the simulated blood vessel 18 more closely mimics a real blood vessel.

As a force F is applied to the central section 30 the body 20 is compressed. As the body 20 is compressed the central section 30 begins to compress in height and the central section 30 simultaneously expands in the width-wise direction. The compressed, elliptical shape of the central section 30 is such that the distance the central section 30 must be compressed in height in order to occlude the channel 22 is less relative to the width w than for a circular cross section.

To enable the central section 30 to more easily expand width-wise, compression channels 32 are moulded within the body 20 and are arranged parallel to the fluid channel 22 on opposing sides of the fluid channel 22 in the width-wise direction. The compression channels 32 are hollow compressible channels and are configured and arranged to compress as the central section 30 expands in the width-wise direction. The compression channels thereby increase the compressibility of the body 20 in the regions either side of the central section 30. As such, the resistance to the width-wide expansion of the central section 30 is reduced and the central section 30 is able to be more easily compressed. Alternatively, the body 20 may include compression zones located width-wise either side of the central section 30. The compression zones may be formed of a material, which may be silicone or another material, which has a greater compressibility, which may also be expressed as a lower Shore hardness, than the material forming the rest of the body 20.

The body 20 is formed as an elongate strip of rectangular cross section, although alternative cross-sections may also be utilised. The body 20 is moulded, and the mould includes a core having a shape corresponding to the shape of the central section 30. Cylindrical inserts are also provided in the mould to form the compression channels 32. The silicone body 20 is formed about the core and the inserts. Once the body 20 cured the core and the inserts are removed from the body 20. The silicone material forming the body 20 has a Shore hardness selected to enable is to expand sufficiently to allow the expanded central section 30 to be withdrawn through one of the end sections.

The moulded body 20 is pre-formed and arranged within the structure of the leg 8 during assembly, and prior to casting of the skin. Alternatively, the body 20 may comprise an integrally moulded part of the leg 8, and the channels 20 and 32 may be formed during moulding of the leg 8 or other body section.

1. A simulated blood vessel for use in a trauma simulator, the simulated blood vessel comprising:
a flexible, resilient body; and
a fluid channel integrally moulded within the body, the fluid channel having first and second ends and a compression zone located lengthwise between the first and second ends that is compressible between an open configuration and a closed configuration in which flow through the fluid channel is blocked;
wherein the compression zone has a compression axis arranged transverse to the length of the fluid channel along which a compression force is applied to the fluid channel in use, and the compression zone has a cross sectional shape having a first axis aligned with the compression axis and a second axis arranged transverse to the first axis, and the diameter of the fluid channel along the second axis is greater than diameter along the first axis to enable the fluid channel to be more easily compressed to the closed configuration.

2. The simulated blood vessel according to claim 1, wherein the first end of the fluid channel defines an inlet and the second end defines an outlet and the first end of the fluid channel has a circular cross section.

3. The simulated blood vessel according to claim 2, wherein the cross-sectional shape of the fluid channel transitions along the length of the channel in a tapered manner from the circular cross sectional shape at the first end to the cross sectional shape of the compression zone.

4. The simulated blood vessel according to claim 2, wherein the second end of end of the fluid channel has a circular cross section.

5. The simulated blood vessel according to claim 4, wherein the cross sectional shape of the fluid channel transitions along the length of the channel in a tapered manner from the cross sectional shape of the compression zone to the circular cross-sectional shape at the first end.

6. The simulated blood vessel according to claim 1, wherein the compression zone has an elliptical cross-sectional shape.

7. The simulated blood vessel according to claim 1, wherein the body is formed from silicone.

8. The simulated blood vessel according to claim 1, wherein the body has an elongate cuboid form and the fluid channel is arranged lengthwise within the body.

9. The simulated blood vessel according to claim 1 further comprising first and second expansion zones located on opposing sides of the compression zone along the second axis, and the expansion zones are regions within the body having a greater compressibility than the rest of the body to enable the compression zone to more easily expand outwardly along the second axis when compressed along the first axis.

10. The simulated blood vessel according to claim 9, wherein the first and second expansion zones include first and second compression channels integrally moulded within the body and arranged parallel to the fluid channel and such that they compress as the compression zone expands outwardly along the second axis.

11. The simulated blood vessel according to claim 9, wherein the first and second expansion zones comprise a material of greater compressibility than the rest of the body.

12. A trauma simulator comprising a model simulating a human body or part thereof containing an assembly of simulated internal body parts arranged to replicate the internal structure of the body or body part simulated by the model;
wherein the assembly of simulated body parts includes the simulated blood vessel according to claim 1.

13. The trauma simulator according to claim 12 wherein the first end of the fluid channel is arranged for connection to a fluid supply for the supply of simulated blood, the second end is located at a region of the model simulating a wound and is arranged to create an external flow of simulated blood, and the compression zone is located at a region within the model corresponding to the location on a blood vessel to which a compression technique is to be applied, the compression zone being located such that application of a predetermined compression force to the model causes the compression zone to compress to the closed configuration.

14. The trauma simulator according to claim 1, wherein the assembly of simulated internal body parts includes simulated bone and simulated muscle tissue and an outer skin surrounding the internal body parts; and
wherein the simulated blood vessel is located within the model between the outer skin and one of both of the simulated bone and the simulated muscle tissue, which provide a substrate that is less compressible than the body of the simulated blood vessel against which the simulated blood vessel may be compressed.

15. The simulated blood vessel according to claim 3, wherein the second end of end of the fluid channel has a circular cross section.

16. The simulated blood vessel according to claim 15, wherein the cross sectional shape of the fluid channel transitions along the length of the channel in a tapered manner from the cross sectional shape of the compression zone to the circular cross-sectional shape at the first end.

17. A simulated blood vessel for use in a trauma simulator, the simulated blood vessel comprising:
a flexible, resilient body;
a fluid channel integrally moulded within the body, the fluid channel having first and second ends and a compression zone located lengthwise between the first and second ends that is compressible between an open configuration and a closed configuration in which flow through the fluid channel is blocked; and
first and second expansion zones located on opposing sides of the compression zone along the second axis, and the expansion zones are regions within the body having a greater compressibility than the rest of the body to enable the compression zone to more easily expand outwardly along the second axis when compressed along the first axis;
wherein the compression zone has a compression axis arranged transverse to the length of the fluid channel along which a compression force is applied to the fluid channel in use, and the compression zone has a cross sectional shape having a first axis aligned with the compression axis and a second axis arranged transverse to the first axis, and the diameter of the fluid channel along the second axis is greater than diameter along the first axis to enable the fluid channel to be more easily compressed to the closed configuration.

18. The simulated blood vessel according to claim 17, wherein the first and second expansion zones include first and second compression channels integrally moulded within the body and arranged parallel to the fluid channel and such that they compress as the compression zone expands outwardly along the second axis; and
wherein the first and second expansion zones comprise a material of greater compressibility than the rest of the body.

19. The simulated blood vessel according to claim 18, wherein the first end of the fluid channel defines an inlet and the second end defines an outlet and the first end of the fluid channel has a circular cross section;
wherein the cross-sectional shape of the fluid channel transitions along the length of the channel in a tapered manner from the circular cross-sectional shape at the first end to the cross-sectional shape of the compression zone; and
wherein the second end of end of the fluid channel has a circular cross section.

20. The simulated blood vessel according to claim 19, wherein the cross sectional shape of the fluid channel transitions along the length of the channel in a tapered manner from the cross sectional shape of the compression zone to the circular cross-sectional shape at the first end;
wherein the compression zone has an elliptical cross-sectional shape;
wherein the body is formed from silicone; and
wherein the body has an elongate cuboid form and the fluid channel is arranged lengthwise within the body.
